(19) United States
(12) Patent Application Publication
(10) Pub. No.: US 2026/0078820 A1
(43) Pub. Date: Mar. 19, 2026

(54) SYSTEM AND METHOD FOR TRANSMISSION SHIFTING

(71) Applicant: Dana Belgium N.V., Brugge (BE)

(72) Inventors: Stijn GOOSSENS, Erpe-Mere (BE); Nicolas LENAERTS, Brugge (BE)

(21) Appl. No.: 18/887,408

(22) Filed: Sep. 17, 2024

(51) Int. Cl. F16H 61/688; F16H 3/00; F16H 61/04

(52) U.S. Cl. CPC F16H 61/688; F16H 3/006; F16H 2003/008; F16H 2061/0422

(57) ABSTRACT

Methods and systems for shifting a transmission that includes two input shafts configured to be driven via two different power sources is shown. The systems and methods include shifting into an intermediate gear mode where two different gears coupled to an output shaft of a transmission are driven simultaneously. The approach allows battery power to be conserved during gear shifting and simplification of performing off-road maneuvers.

### TECHNICAL FIELD

The present disclosure relates to operating a transmission that includes two dog clutches to selectively link two power sources to a sole output shaft of the transmission.

### BACKGROUND AND SUMMARY

A transmission may include one or more dog clutches to enable the transmission to shift from a first gear to a second gear. In order to smoothly engage a dog clutch to a gear, a portion of the dog clutch may be increased in speed or decreased in speed so that the portion of the dog clutch rotates at a same speed of the gear. Once the portion of the dog clutch is rotating at the rotational speed of the gear to be engaged, the dog clutch may be engaged to the gear. By synchronizing a rotational speed of a portion of a dog clutch with a rotational speed of a gear, a possibility of dog clutch teeth skipping over gear teeth may be reduced. Additionally, meshing of dog clutch teeth to gear teeth may be enhanced. However, increasing or decreasing dog clutch rotational speed to match gear rotational speed in a short amount of time may also involve increasing or decreasing a speed of an electric machine and transmission components that are between the electric machine and the dog clutch. This may result in rather large amounts of electric power being consumed or being generated by the electric machine. As a result, power capacity of the battery may have to be increased, thereby increasing the weight and financial expense of the battery.

The inventors herein have recognized the above-mentioned issues and have developed a method for operating a transmission, comprising: operating the transmission in a first gear via supplying torque to a first transmission output shaft gear via a first electric machine while simultaneously supplying torque to the first transmission output shaft gear via a second electric machine, where torque supplied via the first electric machine plus torque supplied via the second electric machine generates a transmission output torque that follows a driver demand transmission output torque; and operating the transmission in an intermediate gear mode via supplying torque to the first transmission output shaft gear via the first electric machine while simultaneously supplying torque to a second transmission output shaft gear via the second electric machine, where torque supplied via the first electric machine plus torque supplied via the second electric machine generates the transmission output torque that follows the driver demand transmission output torque.

By engaging two different transmission output shaft gears simultaneously to two different electric machines, it may be possible to spread dog clutch transitions (e.g., from disengaging a gear to engaging a gear) over a much wider electric machine speed range and to adjust dog clutches at different times so that the rate of speed change of the electric machines to shift the transmission may be reduced. As a result, it may be possible avoid increasing the capacity of the vehicle's battery. Further, the ability to move the dog clutches at different times allows one electric machine to meet driver demand torque while the other electric machine is meeting driver demand torque so that the shift may result in little or no decline from a requested transmission output torque.

The present description may provide several advantages. In particular, the approach may allow battery power capacity to be maintained or lowered while providing a desired level of vehicle performance. Further, the approach may provide for smoother gear shifts. Additionally, the approach may have more robustness against de-rating a powertrain's electric machines.

It is to be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not restricted to implementations that solve any disadvantages noted above or in any part of this disclosure.

### BRIEF DESCRIPTION OF THE DRAWINGS

FIG. 1 is an illustration of an example vehicle that includes an electric vehicle propulsion system.

FIG. 2 shows a stick diagram of one example step gear ratio transmission configuration that includes two electric machines.

FIG. 3 shows transmission operating ranges according to transmission output torque and transmission output speed.

FIG. 4 shows a flowchart of an example method for operating a transmission.

FIG. 5 shows an example transmission operating sequence.

### DETAILED DESCRIPTION

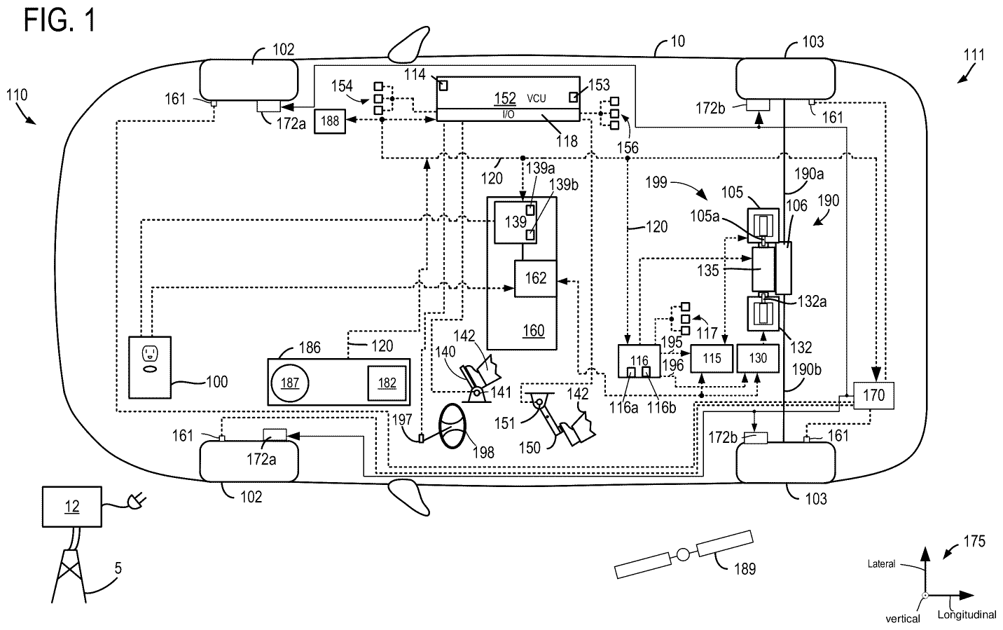

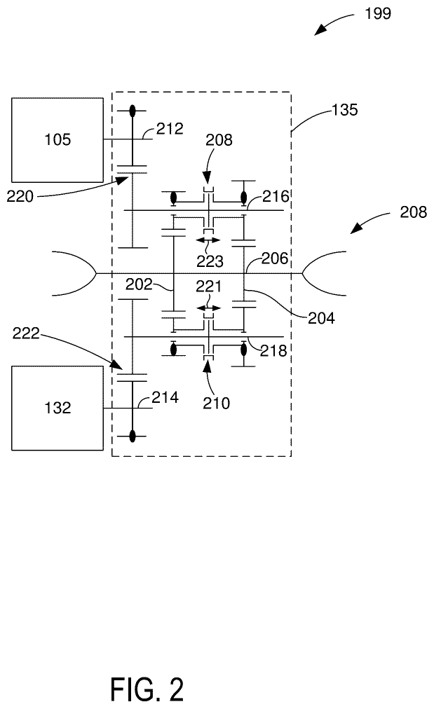

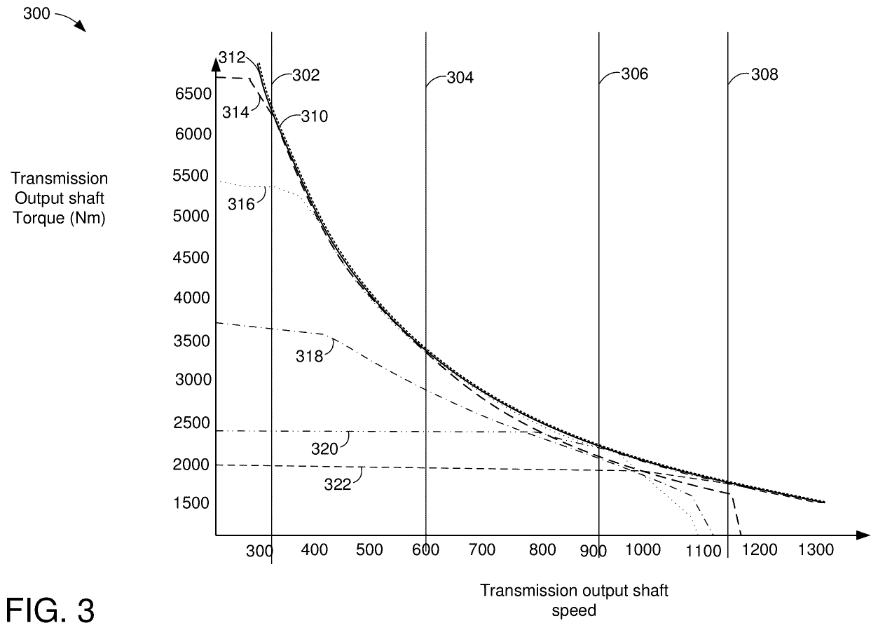

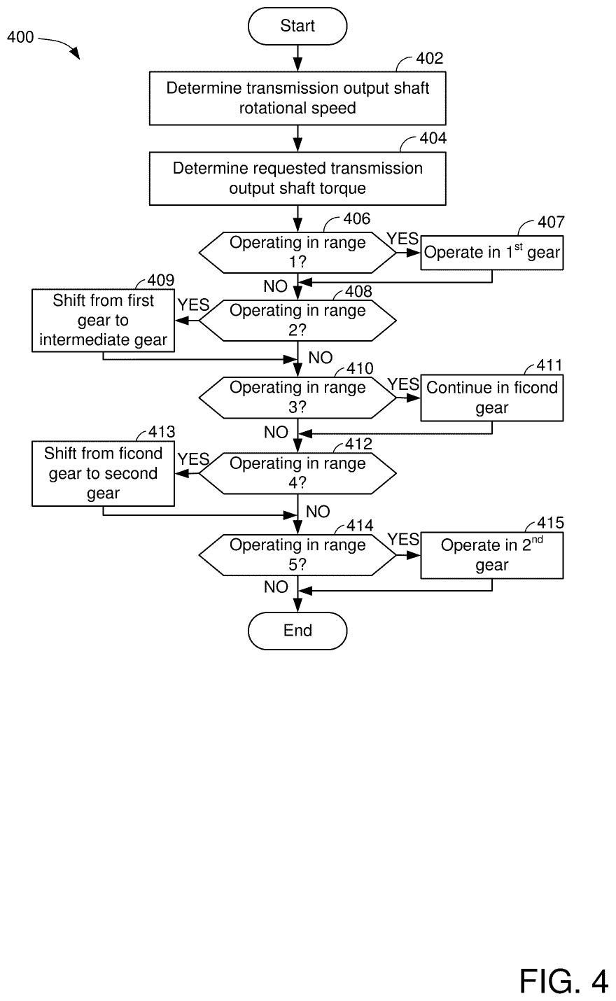

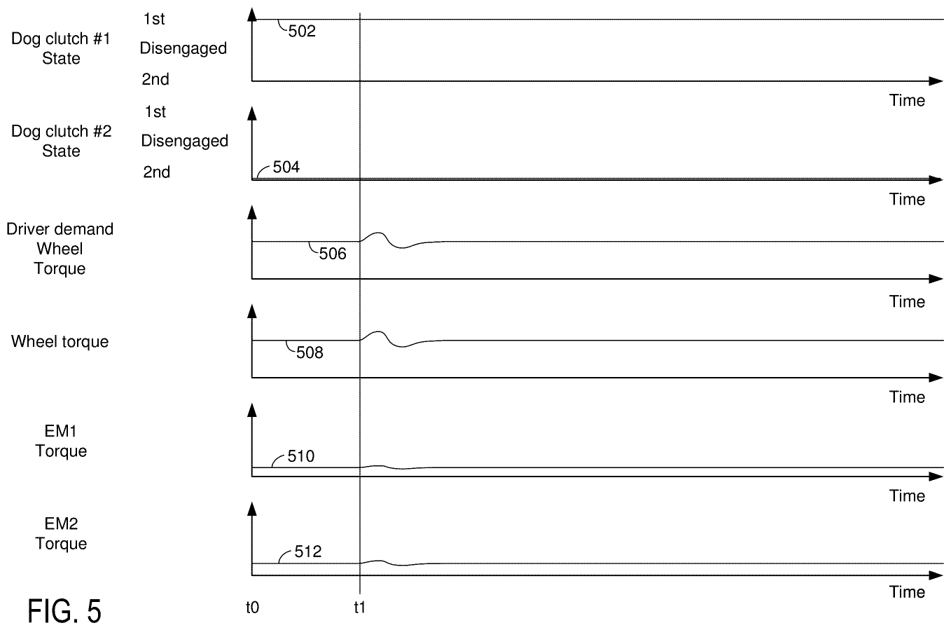

A method and system for shifting a transmission is described. The transmission may be mechanically coupled to two electric machines. The electric machines may have equal capacities (e.g., power output) or the electric machines may have different capacities. The shifting method operates a transmission that includes two gears coupled to an output shaft in three different modes such that the transmission has three distinct gear selections. This allows dog clutch engagement and disengagements to occur at different vehicle speeds so that the electric machines may not consume or generate as much electric power during gear shifting as other gear shifting approaches. An example electric vehicle configuration is shown in FIG. 1. The electric vehicle may include a transmission and electric machines as shown in FIG. 2. Operating ranges for the electric vehicle are shown in FIG. 3. A method for operating the transmission is shown in FIG. 4. Finally, an example transmission operating sequence is shown in FIG. 5.

FIG. 1 illustrates an example vehicle propulsion system 199 for vehicle 10. In FIG. 1, mechanical connections between the various components are illustrated as solid lines, whereas electrical connections between various components are illustrated as dashed lines. Vehicle front end is indicated at 110 and vehicle rear end is indicated at 111. Vehicle 10 travels in a forward direction when vehicle front end 110 leads movement of vehicle 10. Vehicle 10 travels in a reverse direction when vehicle rear end 111 leads movement of vehicle 10. In this example, vehicle 10 is a rear wheel drive vehicle, but in other examples, vehicle 10 may be a four-wheel drive or front wheel drive vehicle.

Vehicle propulsion system 199 includes a first propulsion source 105 (e.g., electric machine number one) and a second propulsion source 132 (e.g., electric machine number two). In one example, propulsion sources 105 and 132 may be synchronous or induction electric machines that may operate as motor or generators. In other examples, propulsion sources 105 and 132 may be a direct current (DC) machine. Vehicle propulsion system 199 also includes a transmission 135. The propulsion sources 105 and 132 are fastened to the transmission 135. Propulsion sources 105 and 132 deliver power from their respective rotors 105a and 132a to transmission 135. Transmission 135 may be mechanically coupled to differential gears 106. Differential gears 106 may be coupled to two axle shafts, including a first or right axle shaft 190a and a second or left axle shaft 190b. Vehicle 10 further includes front wheels 102 and rear wheels 103. In this example, first propulsion source 105, second propulsion source 132, and transmission 135 are shown integrated into electrified axle 190. However, it should be appreciated that in other examples, first propulsion source 105, second propulsion source 132, and transmission 135 may be remote from and coupled to an axle via a drive shaft.

The transmission 135 may be referred to as a step ratio transmission and it may be configured as shown in greater detail in FIG. 2. Transmission 135 may include one or more clutch actuators (not shown) to shift one or more clutches. Electric power inverter 115 is electrically coupled to first propulsion source 105 to convert DC power to alternating current (AC) and vise-versa. Likewise, electric power inverter 130 is electrically coupled to second propulsion source 132 to convert DC power to alternating current (AC) and vise-versa. Powertrain controller 116 is electrically coupled to sensors 117 and actuators of vehicle propulsion system 199. For example, sensors 117 may include, but are not constrained to inverter switch temperature sensors, electric machine winding temperature sensors, bus bar temperature sensors, transmission output shaft speed, transmission shaft output torque, etc.

Transmission 135 may transfer mechanical power to or receive mechanical power from differential gears 106. Differential gears 106 may transfer mechanical power to or receive mechanical power from rear wheels 103 via right axle shaft 190a and left axle shaft 190b. Propulsion sources 105 and 132 may consume alternating current (AC) electrical power provided via their respective electric power inverters 115 and 130. Alternatively, propulsion source 105 and 130 may provide AC electrical power to their respective electric power inverters 115 and 130. Electric power inverters 115 and 130 may be provided with high voltage direct current (DC) power from battery 160 (e.g., a traction battery, which also may be referred to as an electric energy storage device or battery pack). Electric power inverters 115 and 130 may convert the DC electrical power from battery 160 into AC electrical power for propulsion sources 105 and 132. Alternatively, electric power inverters 115 and 130 may be provided with AC power from their respective propulsion sources 105 and 130. Electric power inverters 115 and 130 may convert the AC electrical power from their respective propulsion sources 105 and 130 into DC power to store in battery 160.

Propulsion sources 105 and 132 may transfer mechanical power to or receive mechanical power from transmission 135. As such, transmission 135 may be a multi-speed gear set that may shift between gear ratios when commanded via powertrain controller 116. Powertrain controller 116 includes a processor 116a and memory 116b. Memory 116b (e.g., storage media) may include read exclusive memory, random access memory, and keep alive memory. The memory may be programmed with computer readable data representing instructions that are executable by a processor for performing the methods and control techniques described herein as well as other variants that are anticipated but not specifically listed. As such, control techniques, methods, and the like expanded upon herein may be stored as instructions in non-transitory memory.

Battery 160 may periodically receive electrical energy from a power source such as a stationary power grid 5 residing external to the vehicle (e.g., not part of the vehicle). As a non-restricted example, vehicle propulsion system 199 may be configured as a plug-in electric vehicle (EV), whereby electrical energy may be supplied to battery 160 via the stationary power grid 5 and charging station 12. Electric charge may be delivered to battery 160 via plug receptacle 100.

Battery 160 may include a BMS controller 139 (e.g., a battery management system controller) and an electrical power distribution box 162. BMS controller 139 may provide charge balancing between energy storage elements (e.g., battery cells) and communication with other vehicle controllers (e.g., vehicle control unit 152). BMS controller 139 includes a core processor 139a and memory 139b (e.g., random-access memory, read-exclusive memory, and keep-alive memory).

Vehicle 10 may include a vehicle control unit (VCU) 152 that may communicate with powertrain controller 116, friction caliper controller 170, global positioning system (GPS) 188, BMS controller 139, and dashboard 186 and components included therein via controller area network (CAN) 120. VCU 152 includes memory 114, which may include read-exclusive memory (ROM or non-transitory memory) and random access memory (RAM). VCU also includes a digital processor or central processing unit (CPU) 153, and inputs and outputs (I/O) 118 (e.g., digital inputs including counters, timers, and discrete inputs, digital outputs, analog inputs, and analog outputs). VCU may receive signals from sensors 154 and provide control signal outputs to actuators 156. Sensors 154 may include but are not restricted to lateral accelerometers, longitudinal accelerometers, yaw rate sensors, inclinometers, temperature sensors, battery voltage and current sensors, and other sensors described herein. Additionally, sensors 154 may include steering angle sensor 197, driver demand pedal position sensor 141, vehicle range finding sensors including radio detection and ranging (RADAR), light detection and ranging (LIDAR), sound navigation and ranging (SONAR), and caliper application pedal position sensor 151. Actuators may include but are not constrained to inverters, transmission controllers, display devices, human/machine interfaces, friction caliper systems, and battery controller described herein.

Driver demand pedal position sensor 141 is shown coupled to driver demand pedal 140 for determining a degree of application of driver demand pedal 140 by human 142. Caliper application pedal position sensor 151 is shown coupled to caliper application pedal 150 for determining a degree of application of caliper application pedal 150 by human 142. Steering angle sensor 197 is configured to determine a steering angle according to a position of steering wheel 198.

Vehicle propulsion system 199 is shown with a global position determining system 188 that receives timing and position data from one or more GPS satellites 189. Global positioning system may also include geographical maps in ROM for determining the position of vehicle 10 and features of roads that vehicle 10 may travel on.

Vehicle propulsion system 199 may also include a dashboard 186 that an operator of the vehicle may interact with. Dashboard 186 may include a display system 187 configured to display information to the vehicle operator. Display system 187 may comprise, as a non-restricting example, a touchscreen, or human machine interface (HMI), display which enables the vehicle operator to view graphical information as well as input commands. In some examples, display system 187 may be connected wirelessly to the internet (not shown) via VCU 152. As such, in some examples, the vehicle operator may communicate via display system 187 with an internet site or software application (app) and VCU 152.

Dashboard 186 may further include an operator interface 182 via which the vehicle operator may adjust the operating status of the vehicle. Specifically, the operator interface 182 may be configured to activate and/or deactivate operation of the vehicle driveline (e.g., first propulsion source 105) based on an operator input. Further, an operator may request an axle mode (e.g., park, reverse, neutral, drive) via the operator interface. Various examples of the operator interface 182 may include interfaces that utilize a physical apparatus, such as a key, that may be inserted into the operator interface 182 to activate the vehicle propulsion system 199, including propulsion sources 105 and 132, to turn on the vehicle 10. The apparatus may be removed to shut down the transmission 135 and propulsion sources 105 and 139 to turn off vehicle 10. Propulsion sources 105 and 130 may be activated via supplying electric power to propulsion sources 105 and 132 as well as electric power inverters 115 and 130. Propulsion sources 105 and 132 may be deactivated by ceasing to supply electric power to propulsion sources 105 and 132 as well as electric power inverters 115 and 132. Still other examples may additionally or optionally use a start/stop button that is manually pressed by the operator to start or shut down the propulsion sources 105 and 132 to turn the vehicle on or off. In other examples, a remote electrified axle or electric machine start may be initiated remote computing device (not shown), for example a cellular telephone, or smartphone-based system where a user's cellular telephone sends data to a server and the server communicates with the vehicle control unit 152 to activate the electric power inverters 115 and 130 as well as propulsion sources 105 and 132. Spatial orientation of vehicle 10 is indicated via axes 175.

Vehicle 10 is also shown with a foundation or friction caliper controller 170. Friction caliper controller 170 may selectively apply and release friction calibers (e.g., 172a and 172b) via allowing hydraulic fluid to flow to the friction calipers. The friction calipers may be applied and released so as to reduce locking of the friction calipers to front wheels 102 and rear wheels 103. Wheel position or speed sensors 161 may provide wheel speed data to friction caliper controller 170. Vehicle propulsion system 199 may provide torque to rear wheels 103 to propel vehicle 10.

A human or autonomous driver 142 may request a driver demand wheel torque, or alternatively a driver demand tractive effort, via applying driver demand pedal 140 or via supplying a driver demand wheel torque/tractive effort request to vehicle control unit 152. Vehicle control unit 152 may then demand a torque or tractive effort from propulsion sources 105 and 132 via commanding powertrain controller 116. Powertrain controller 116 may command electric power inverters 115 and 130 via communications links 195 and 196 to deliver the driver demand wheel torque/tractive effort via electrified axle 190 and propulsion sources 105 and 132. Electric power inverters 115 and 130 may convert DC electrical power from battery 160 into AC power and supply the AC power to propulsion sources 105 and 132. Propulsion sources 105 and 132 rotate and transfer torque/power to transmission 135. Transmission 135 may supply torque from propulsion sources 105 and 132 to differential gears 106, and differential gears 106 transfer torque from propulsion sources 105 and 132 to rear wheels 103 via axle shafts 190a and 190b.

During conditions when the driver demand pedal is fully released, vehicle control unit 152 may request a small negative or regenerative power to gradually slow vehicle 10 when a speed of vehicle 10 is greater than a threshold speed. The amount of regenerative power requested may be a function of driver demand pedal position, battery state of charge (SOC), vehicle speed, and other conditions. If the driver demand pedal 140 is fully released and vehicle speed is less than a threshold speed, vehicle control unit 152 may request a small amount of positive torque/power (e.g., propulsion torque) from propulsion sources 105 and 132, which may be referred to as creep torque or power. The creep torque or power may allow vehicle 10 to remain stationary when vehicle 10 is on a small positive grade.

The human or autonomous driver may also request a negative or regenerative driver demand slowing torque, or alternatively a driver demand slowing power, via applying caliper application pedal 150 or via supplying a driver demand slowing power request to vehicle control unit 152. Vehicle control unit 152 may request that a first portion of the driver demanded slowing power be generated via propulsion sources 105 and 132 via commanding powertrain controller 116. Additionally, vehicle control unit 152 may request that a portion of the driver demanded slowing power be provided via friction calipers 172a and 172b via commanding friction caliper controller 170 to provide a second portion of the driver requested slowing power.

After vehicle control unit 152 determines the slowing power request, vehicle control unit 152 may command powertrain controller 116 to deliver the portion of the driver demand slowing power allocated to propulsion sources 105 and 132. Propulsion sources 105 and 132 may convert the vehicle's kinetic energy into AC power.

Powertrain controller 116 includes predetermined transmission gear shift schedules whereby fixed ratio gears of transmission 135 may be selectively engaged and disengaged. Shift schedules stored in powertrain controller 116 may select gear shift points or events as a function of driver demand wheel torque and vehicle speed.

Turning now to FIG. 2, a stick diagram of vehicle propulsion system 199 is shown. In this example, vehicle propulsion system 199 includes a transmission 135 that is a step gear ratio transmission with two gears that are attached to the transmission's output shaft. In other examples, transmission 135 may include additional gear ratios.

Transmission 135 is mechanically coupled to first electric machine 105 via first input shaft 212. Additionally, transmission 135 is mechanically coupled to second electric machine 132 via second input shaft 214. First input shaft 212 is mechanically coupled to first layshaft 216, or alternatively, a first intermediate shaft via first idler gear 220. Second input shaft 214 is mechanically coupled to second layshaft 218, or alternatively a second intermediate shaft via second idler gear 222. First dog clutch 208 is slidably coupled to first layshaft 216. First dog clutch 208 may engage first gear 202 (e.g., a first transmission output shaft gear) or second gear 204 (e.g., a second transmission output shaft gear). Similarly, second dog clutch 210 is slidably coupled to second layshaft 218. Second dog clutch 210 may engage first gear 202 or second gear 204. First gear 202 is mechanically coupled to output shaft 206. Likewise, second gear 204 is mechanically coupled to output shaft 206. Output shaft 206 may be mechanically coupled to vehicle front wheels and/or rear wheels (not shown) via a drive shaft and differential gears (not shown). First dog clutch 208 may move in a longitudinal direction 223 with respect to first layshaft 216 to selectively engage or couple first gear 202 or second gear 204 to first electric machine 105. Second dog clutch 210 may move in a longitudinal direction 221 with respect to second layshaft 218 to selectively engage or couple first gear 202 or second gear 204 to second electric machine 132.

Transmission 135 may be engaged or operate in first gear when first dog clutch locks first gear 202 to layshaft 216 and input shaft 212 while second dog clutch locks first gear 202 to layshaft 218 and input shaft 212. Transmission 135 may be engaged or operate in second gear when first dog clutch locks second gear 204 to layshaft 216 and input shaft 212 while second dog clutch locks second gear 204 to layshaft 218 and input shaft 212. Transmission 135 may be in an intermediate gear mode, which may be referred to as “ficond gear,” when first dog clutch locks first gear 202 to layshaft 216 and input shaft 212 while second dog clutch locks second gear 204 to layshaft 218 and input shaft 212. Alternatively, transmission 135 may be in the intermediate gear mode when first dog clutch locks second gear 204 to layshaft 216 and input shaft 212 while second dog clutch locks first gear 202 to layshaft 218 and input shaft 212.

The system of FIGS. 1 and 2 provides for an electric propulsion system, comprising: a first electric machine mechanically coupled to a first input shaft of a transmission, the first input shaft coupled to a first layshaft of the transmission; a first dog clutch coupled to the first layshaft; a second electric machine mechanically coupled to a second input shaft of the transmission, the second input shaft coupled to a second layshaft of the transmission; a second dog clutch coupled to the second layshaft; an output shaft of the transmission including a first gear and a second gear; a controller including executable instructions stored in non-transitory memory that cause the controller to engage the first gear to the first electric machine via the first dog clutch while engaging the second gear to the second electric machine via the second dog clutch. In a first example, the electric propulsion system further comprises additional executable instructions that cause the controller to engage the first gear to the first electric machine via the first dog clutch while engaging the first gear to the second electric machine via the second dog clutch. In a second example that may include the first example, the electric propulsion system further comprises additional executable instructions that cause the controller to engage the second gear to the first electric machine via the first dog clutch while engaging the second gear to the second electric machine via the second dog clutch. In a third example that may include one or both of the first and second examples, the electric propulsion system further comprises additional executable instructions that cause the controller to command torque output of the first electric machine to be different from torque output of the second electric machine. In a fourth example that may include one or more of the first through third examples, the electric propulsion system further comprises additional instructions that cause the controller to adjust a position of the first dog clutch in response to a plurality of transmission operation zones. In a fifth example that may include one or more of the first through fourth examples, the electric propulsion system further comprises additional instructions that cause the controller to adjust a position of the second dog clutch in response to a plurality of transmission operation zones. In a sixth example that may include one or more of the first through fifth examples, the electric propulsion system further comprises additional executable instructions that cause the controller to adjust torque output of the first electric machine and torque output of the second electric machine so that output of the transmission follows a driver demand transmission output torque.

Turning now to FIG. 3, a plot 300 of transmission operating ranges according to transmission output torque and transmission output speed is shown. The transmission operating ranges may be indicative of transmission operating modes and the transmission operating modes define which gears may be engaged and disengaged.

The vertical axis of plot 300 represents transmission output shaft torque output and the transmission output shaft torque increases in the direction of the vertical axis arrow. The horizontal axis represents transmission output shaft speed and transmission output shaft speed increases in the direction of the horizontal axis arrow. Plot 300 includes four vertical dividing lines (302-308) and these lines represent boundaries of transmission operating ranges.

A first transmission operating range is bounded by the horizontal axis, the vertical axis, and vertical line 302. This first transmission operating range is a transmission torque/speed range where the transmission may be operated in first gear. In this example, vertical line 302 is shown at about 315 revolutions/minute (RPM). A second transmission operating range is bounded by the horizontal axis, vertical line 302, and vertical line 304. This second transmission operating range is a transmission torque/speed range where the transmission may be shifted from the first gear to the intermediate or ficond gear. In this example, vertical line 304 is shown at about 600 RPM. A third transmission operating range is bounded by the horizontal axis, vertical line 304, and vertical line 306. This third transmission operating range is a transmission torque/speed range where the transmission may continue to be operated in ficond gear. In this example, vertical line 306 is shown at about 910 RPM. A fourth transmission operating range is bounded by the horizontal axis, vertical line 306, and vertical line 308. This fourth transmission operating range is a transmission torque/speed range where the transmission may be shifted from the ficond gear to second gear. In this example, vertical line 308 is shown at about 1140 RPM. A fifth transmission operating range is bounded by the horizontal axis and vertical line 308. This fifth transmission operating range is a transmission torque/speed range where the transmission may continue to be operated in second gear. It may be understood that the transmission torques and speeds that define the operating ranges shown in FIG. 3 may take on different values in other examples and therefore are not to be considered as constraining this disclosure.

Dashed line 310 represents a maximum power output of transmission. Solid line 312 represents transmission power output constrained to 210 kW via two electric machines operating with peak power output while the transmission is operated with gear ratios 7.49:1 (e.g., first gear) and 2.67:1 (e.g., second gear) activated to provide an intermediate gear ratio. Large dash line 314 represents transmission power output constrained to 210 kW via one electric machine operating with peak power output while the transmission is operated with gear ratios 7.49:1 (e.g., first gear) activated to provide a first gear. Dotted line 316 represents transmission power output constrained to 210 kW via two electric machines operating with continuous power output while the transmission is operated with gear ratios 7.49:1 (e.g., first gear) and 7.49:1 (e.g., first gear) activated to provide the first gear ratio. Dash dot line 318 represents transmission power output constrained to 210 kW via two electric machines with continuous power output while the transmission is operated with gear ratios 7.49:1 (e.g., first gear) and 7.49:1 (e.g., first gear) activated to provide the first gear ratio. Dash double dot line 320 represents transmission power output constrained to 210 kW via one electric machine operating with peak power output while the transmission is operated with gear ratios 2.67:1 (e.g., second gear) activated to provide a second gear. Dashed line 322 represents transmission power output constrained to 210 kW via two electric machines operating with continuous power output while the transmission is operated with gear ratios 2.67:1 (e.g., second gear) and 2.67:1 (e.g., second gear) activated to provide the second gear ratio.

Thus, transmission 315 may be shifted from first to ficond gear based on vehicle operating conditions while the transmission is operating anywhere in the second range. Similarly, transmission 315 may be shifted from ficond gear to second gear based on vehicle operating conditions while the transmission is operating anywhere in the fourth range.

Referring now to FIG. 4, a flowchart of method 400 for operating a transmission is shown. The method of FIG. 4 may be incorporated into and may cooperate with the system of FIGS. 1 and 2. Further, at least portions of the method of FIG. 4 may be incorporated as executable instructions stored in non-transitory memory of one or more controllers while other portions of method 400 may be performed via the one or more controllers transforming operating states of devices and actuators in the physical world.

At 402, method 400 determines a transmission output shaft rotational speed. The rotational speed may be determined via a speed sensor. Method 400 proceeds to 404.

At 404, method 400 determines a transmission output shaft torque. The transmission output shaft torque may be determined via multiplying torque output of the first electric machine by a gear ratio between the first electric machine and the transmission output shaft plus torque output of the second electric machine multiplied by a gear ratio between the second electric machine and the transmission output shaft. The torque at the output shaft of the transmission may be generated based on driver demand torque that is input to driver demand pedal 140 via a driver and the input to the driver demand pedal may be converted into a driver demand transmission output torque or alternatively a driver demand wheel torque. The driver demand wheel torque may be converted to a transmission output shaft torque by dividing the driver demand wheel torque by the gear ratio that is between the vehicle's wheels and the transmission output shaft.

At 406, method 400 judges whether or not the transmission is operating in the first transmission operating range. If so, the answer is yes and method 400 proceeds to 407. Otherwise, the answer is no and method 400 proceeds to 408.

At 407, method 400 operates the transmission in first gear as previously described. The transmission output torque follows a driver demanded transmission output torque while the transmission is operating in first gear. Method 400 proceeds to 408.

At 408, method 400 judges whether or not the transmission is operating in the second operating range. If so, the answer is yes and method 400 proceeds to 409. Otherwise, the answer is no and method 400 proceeds to 410.

At 409, method 400 shifts the transmission from first gear to the intermediate gear mode as previously described. The particular transmission output shaft speed and output shaft torque that the transmission is shifted into intermediate gear mode may be based on other operating conditions such as battery state of charge (SOC), electric machine efficiency, and electric machine temperature. The two electric machines may be operated together to generate a driver demand transmission output torque and deliver a highest possible constant power over the transmission output shaft speed range. The transmission output torque follows a driver demanded transmission output torque while the transmission is shifting. Method 400 proceeds to 410.

At 410, method 400 judges whether or not the transmission is operating in the third operating range. If so, the answer is yes and method 400 proceeds to 411. Otherwise, the answer is no and method 400 proceeds to 412.

At 411, method 400 operates the transmission in the intermediate gear mode as previously described. The transmission output torque follows a driver demanded transmission output torque while the transmission is operating in the intermediate gear mode. Method 400 proceeds to 412.

At 412, method 400 judges whether or not the transmission is operating in the fourth operating range. If so, the answer is yes and method 400 proceeds to 413. Otherwise, the answer is no and method 400 proceeds to 414.

Optionally, or alternatively, method 400 may operate in the intermediate gear part of the time by engaging the first dog clutch 208 to first gear 202 and engaging second dog clutch 210 to second gear 204. However, method 400 may operate in the intermediate gear at other times by engaging the first dog clutch 208 to second gear 204 and engaging second dog clutch 210 to first gear 202. This may extend durability of the transmission. During these conditions, one of the first electric machine 105 and the second electric machine 132 may be outputting different torque and power than the other.

At 413, method 400 shifts the transmission from intermediate gear mode to second gear as previously described. The particular transmission output shaft speed and output shaft torque that the transmission is shifted into intermediate gear mode may be based on other operating conditions such as battery state of charge (SOC), electric machine efficiency, and electric machine temperature. The transmission output torque follows a driver demanded transmission output torque while the transmission is shifting. Method 400 proceeds to 414.

At 414, method 400 judges whether or not the transmission is operating in the fifth transmission operating range. If so, the answer is yes and method 400 proceeds to 415. Otherwise, the answer is no and method 400 proceeds to exit.

At 415, method 400 operates the transmission in second gear as previously described. The transmission output torque follows a driver demanded transmission output torque while the transmission is operating in second gear. Method 400 proceeds to exit.

In this way, a transmission may be operated so that the operating range that gears may be shifted within may be increased. This may allow electric machines with lower power capacity or batteries with lower power capacity to meet vehicle design objectives. Further, the transmission may be operated in a mode where two different gears of an output shaft are engaged to provide an additional gear. This may allow the transmission to shift quicker and to provide a transmission output torque that follows a driver demand transmission output torque without experiencing torque perturbations during the shifting.

Thus, the method of FIG. 4 provides for a method for operating a transmission, comprising: operating the transmission in a first gear via supplying torque to a first transmission output shaft gear via a first electric machine while simultaneously supplying torque to the first transmission output shaft gear via a second electric machine, where torque supplied via the first electric machine plus torque supplied via the second electric machine generates a transmission output torque that follows a driver demand transmission output torque; and operating the transmission in an intermediate gear mode via supplying torque to the first transmission output shaft gear via the first electric machine while simultaneously supplying torque to a second transmission output shaft gear via the second electric machine, where torque supplied via the first electric machine plus torque supplied via the second electric machine generates the transmission output torque that follows the driver demand transmission output torque. In a first example, the method further comprises: operating the transmission in a second gear via supplying torque to the second transmission output shaft gear via the first electric machine while simultaneously supplying torque to the second transmission output shaft gear via the second electric machine, where torque supplied via the first electric machine plus torque supplied via the second electric machine generates the transmission output torque that follows the driver demand transmission output torque. In a second example that may include the first example, the method includes where transmission is operated in the first gear in a first operating zone of the transmission. In a third example that may include one or both of the first and second examples, the method further comprises shifting the transmission into the intermediate gear mode in a second operating zone of the transmission. In a fourth example that may include one or more of the first through third examples, the method includes where transmission is operated in the intermediate gear mode in a third operating zone of the transmission. In a fifth example that may include one or more of the first through fourth examples, the method further comprises shifting the transmission into the second gear in a fourth operating zone of the transmission. In a sixth example that may include one or more of the first through fifth examples, the method includes where transmission is operated in second gear in a fifth operating zone of the transmission. In a seventh example that may include one or more of the first through sixth examples, the method includes where when operating in the intermediate gear mode, torque output of the first electric machine is different than torque output of the second electric machine.

The method of FIG. 4 also provides for a method for operating a transmission, comprising: operating the transmission in an intermediate gear mode where a first gear is engaged to a first electric machine via a first dog clutch while a second gear is engaged to a second electric machine via a second dog clutch, where the first gear is directly coupled to an output shaft of the transmission, and where the second gear is directly coupled to the output shaft of the transmission; and generating a transmission output torque that follows a driver demand transmission output torque while the transmission is operating in the intermediate gear mode. In a first example, the method for operating the transmission further comprises operating the transmission in low gear where the first gear is engaged to the first electric machine via the first dog clutch while the first gear is engaged to the second electric machine via the second dog clutch. In a second example that may include the first example, the method for operating the transmission further comprises operating the transmission in high gear where the second gear is engaged to the first electric machine via the first dog clutch while the second gear is engaged to the second electric machine via the second dog clutch. In a third example that may include one or both of the first and second examples, the method for operating the transmission includes where the first dog clutch and the second dog clutch are fully engaged. In a fourth example that may include one or more of the first through third examples, the method for operating the transmission includes where the driver demand transmission output torque increases and decreases a plurality of times while the transmission is operating in the intermediate gear mode.

Referring now to FIG. 5, plots illustrating an example transmission operating sequence is shown. The transmission operating sequence of FIG. 5 may be provided via the system of FIGS. 1 and 2 in cooperation with the method of FIG. 4.

The first plot from the top of FIG. 5 is a plot of the operating state of a first dog clutch 208 of the transmission 135. The first dog clutch operating state may be engaged to first gear, disengaged, or engaged to second gear. The vertical axis represents the dog clutch state and the horizontal axis represents time. Time increases from the left side of the plot to the right side of the plot.

The second plot from the top of FIG. 5 is a plot of the operating state of a second dog clutch 210 of the transmission 135. The second dog clutch operating state may be engaged to first gear, disengaged, or engaged to second gear. The vertical axis represents the dog clutch state and the horizontal axis represents time. Time increases from the left side of the plot to the right side of the plot.

The third plot from the top of FIG. 5 is a plot of driver demand wheel torque versus time. The vertical axis represents driver demand wheel torque and the driver demand wheel torque amount increases in the direction of the vertical axis arrow. The horizontal axis represents time and the time increases from the left side of the plot to the right side of the plot.

The fourth plot from the top of FIG. 5 is a plot of wheel torque versus time. The vertical axis represents wheel torque and the wheel torque amount increases in the direction of the vertical axis arrow. The horizontal axis represents time and the time increases from the left side of the plot to the right side of the plot.

The fifth plot from the top of FIG. 5 is a plot of electric machine number one torque versus time. The vertical axis represents electric machine number one torque and the electric machine number one torque amount increases in the direction of the vertical axis arrow. The horizontal axis represents time and the time increases from the left side of the plot to the right side of the plot.

The fifth plot from the top of FIG. 5 is a plot of electric machine number one torque versus time. The vertical axis represents electric machine number one torque and the electric machine number one torque amount increases in the direction of the vertical axis arrow. The horizontal axis represents time and the time increases from the left side of the plot to the right side of the plot.

At time t0, the first dog clutch is engaging first gear and the second dog clutch is engaging the second gear. The driver demand wheel torque is at a middle level and the wheel torque is substantially equal to the driver demand wheel torque. The torque output of the first electric machine is providing a first amount of torque to the transmission and torque output of the second electric machine is providing a second amount of torque to the transmission. The first electric machine contributes to half of the driver demand torque through the first gear and the second electric machine contributes half of the driver demand torque through the second gear.

At time t1, the first dog clutch remains engaging first gear and the second dog clutch remains engaging the second gear. The driver demand wheel torque starts to change to follow input to the driver demand pedal. The wheel torque follows the driver demand torque. The torque output of the first electric machine is adjusted to provide an amount of torque to the transmission and torque output of the second electric machine is adjusted to provide a second amount of torque to the transmission. The first electric machine continues to contribute to half of the driver demand torque through the first gear and the second electric machine continues to contribute half of the driver demand torque through the second gear.

Thus, output of the first and second electric machines may be adjusted while the first and second electric machines are coupled to different gears to generate the driver demand wheel torque. This may allow the transmission to provide smoother shifting between the gears and to extend dog clutch transitions over a wider vehicle speed range.

Note that the example control and estimation routines included herein may be used with various powertrain and/or vehicle system configurations. The control methods and routines disclosed herein may be stored as executable instructions in non-transitory memory and may be carried out by the control system including the controller in combination with the various sensors, actuators, and other transmission and/or vehicle hardware. Further, portions of the methods may be physical actions taken in the real world to change a state of a device. Thus, the described actions, operations and/or functions may graphically represent code to be programmed into non-transitory memory of the computer readable storage medium in the vehicle and/or transmission control system. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the examples described herein, but is provided for ease of illustration and description. One or more of the illustrated actions, operations and/or functions may be repeatedly performed depending on the particular strategy being used. One or more of the method steps described herein may be omitted if desired.

While various embodiments have been described above, it is to be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology may be applied to electric vehicles and hybrid vehicles including induction and synchronous electric machines. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for operating a transmission, comprising:
operating the transmission in a first gear via supplying torque to the first gear, where the first gear is a first transmission output shaft gear, via a first electric machine while simultaneously supplying torque to the first gear via a second electric machine, where the first gear is engaged to the first electric machine via a first dog clutch, where the first dog clutch is slidably coupled to a first layshaft and moves a longitudinal direction to engage the first gear, where the first gear is engaged to the second electric machine via a second dog clutch, where the second dog clutch is slidably coupled to a second layshaft and moves along the longitudinal direction to engage the first gear, and where torque supplied via the first electric machine plus torque supplied via the second electric machine generates a transmission output torque that follows a driver demand transmission output torque; and
operating the transmission in an intermediate gear mode via supplying torque to the first gear via the first electric machine while simultaneously supplying torque to a second gear via the second electric machine, where the second gear is a second transmission output shaft gear, where the first electric machine is engaged to one of the first gear or the second gear via the first dog clutch while the remaining transmission output shaft gear is engaged to the second electric machine via the second dog clutch, and where torque supplied via the first electric machine plus torque supplied via the second electric machine generates the transmission output torque that follows the driver demand transmission output torque.

2. The method for operating the transmission of claim 1, further comprising:
operating the transmission in the second gear via supplying torque to the second gear via the first electric machine while simultaneously supplying torque to the second gear via the second electric machine, where the second gear is engaged to the first electric machine via the first dog clutch and the second gear is engaged to the second electric machine via the second dog clutch, and where torque supplied via the first electric machine plus torque supplied via the second electric machine generates the transmission output torque that follows the driver demand transmission output torque.

3. The method for operating the transmission of claim 2, where transmission is operated in the first gear in a first operating zone of the transmission.

4. The method for operating the transmission of claim 3, further comprising shifting the transmission into the intermediate gear mode in a second operating zone of the transmission.

5. The method for operating the transmission of claim 4, where transmission is operated in the intermediate gear mode in a third operating zone of the transmission.

6. The method for operating the transmission of claim 5, further comprising shifting the transmission into the second gear in a fourth operating zone of the transmission.

7. The method for operating the transmission of claim 6, where transmission is operated in second gear in a fifth operating zone of the transmission.

8. The method for operating the transmission of claim 1, where when operating in the intermediate gear mode, torque output of the first electric machine is different than torque output of the second electric machine, and where the first dog clutch and the second dog clutch move in opposite directions along the longitudinal direction.

9. An electric propulsion system, comprising:
a first electric machine and a second electric machine arranged on an input side of a transmission;
an output side of the transmission opposite the input side;
an output shaft of the transmission including a first gear and a second gear;
the first electric machine mechanically coupled to a first input shaft of the transmission, the first input shaft coupled to a first layshaft of the transmission;
a first dog clutch is slidably coupled to the first layshaft, where the first dog clutch moves along a longitudinal direction to engage and disengage the first gear, and where the first dog clutch moves along the longitudinal direction to engage and disengage the second gear;
the second electric machine mechanically coupled to a second input shaft of the transmission, the second input shaft coupled to a second layshaft of the transmission;
a second dog clutch is slidably coupled to the second layshaft, where the second dog clutch moves along the longitudinal direction to engage and disengage the first gear, and where the second dog clutch moves along the longitudinal direction to engage and disengage the second gear;
a controller including executable instructions stored in non-transitory memory that cause the controller to selectively engage and disengage the first gear and the second gear to the first electric machine via the first dog clutch and to selectively engage and disengage the first gear and the second gear to the second electric machine via the second dog clutch.

10. The electric propulsion system of claim 9, further comprising additional executable instructions that cause the controller to engage the first gear to the first electric machine via the first dog clutch while engaging the first gear to the second electric machine via the second dog clutch, where the first dog clutch and the second dog clutch are moved along the longitudinal direction toward the first gear.

11. The electric propulsion system of claim 10, further comprising additional executable instructions that cause the controller to engage the second gear to the first electric machine via the first dog clutch while engaging the second gear to the second electric machine via the second dog clutch, where the first dog clutch and the second dog clutch are moved along the longitudinal direction toward the second gear.

12. The electric propulsion system of claim 11, further comprising additional executable instructions that cause the controller to command torque output of the first electric machine to different from torque output of the second electric machine.

13. The electric propulsion system of claim 9, further comprising additional instructions that cause the controller to adjust a position of the first dog clutch in response to a plurality of transmission operation zones.

14. The electric propulsion system of claim 9, further comprising additional instructions that cause the controller to adjust a position of the second dog clutch in response to a plurality of transmission operation zones.

15. The electric propulsion system of claim 9, further comprising additional executable instructions that cause the controller to adjust torque output of the first electric machine and torque output of the second electric machine so that output of the transmission follows a driver demand transmission output torque, where the first dog clutch and the second dog clutch move in a first longitudinal direction toward the first gear to engage the first gear in a first gear mode, where the first dog clutch and the second dog clutch move in a second longitudinal direction toward the second gear to engage the second gear in a second gear mode, and where the first dog clutch and the second dog clutch move in opposite directions to engage the first gear and the second gear in an intermediate gear mode.

16. A method for operating a transmission, comprising:
operating the transmission in an intermediate gear mode, where the transmission contains two transmission output shaft gears including a first gear and a second gear, where one of the two transmission output shaft gears is engaged to a first electric machine via a first dog clutch, where the first dog clutch is slidably coupled to a first layshaft and moves along a longitudinal direction to engage the first gear or to engage the second gear, while the remaining transmission output shaft gear is engaged to a second electric machine via a second dog clutch, where the second dog clutch is slidably coupled to a second layshaft and moves along a longitudinal direction to engage the first gear or to engage the second gear, where the first gear is directly coupled to an output shaft of the transmission, and where the second gear is directly coupled to the output shaft of the transmission; and
generating a transmission output torque that follows a driver demand transmission output torque while the transmission is operating in the intermediate gear mode.

17. The method for operating the transmission of claim 16, further comprising operating the transmission in low gear, where the first gear is engaged to the first electric machine via the first dog clutch while the first gear is engaged to the second electric machine via the second dog clutch, and where the first dog clutch and the second dog clutch are moved along the longitudinal direction.

18. The method for operating the transmission of claim 17, further comprising operating the transmission in high gear, where the second gear is engaged to the first electric machine via the first dog clutch while the second gear is engaged to the second electric machine via the second dog clutch, and where the first dog clutch and the second dog clutch are moved along the longitudinal direction.

19. The method for operating the transmission of claim 16, further comprising in an alternative mode, operating the transmission in the intermediate gear mode, where the second gear is engaged to the first electric machine via a first dog clutch while the first gear is engaged to the second electric machine via the second dog clutch, and where the first dog clutch is moved along the longitudinal direction and the second dog clutch is moved along the longitudinal direction.

20. The method for operating the transmission of claim 16, where the driver demand transmission output torque increases and decreases a plurality of times while the transmission is operating in the intermediate gear mode, and where the first dog clutch and the second dog clutch move in opposite directions when initiating the intermediate gear mode.
